(19) United States
(12) Patent Application Publication
(10) Pub. No.: US 2003/0072979 A1
(43) Pub. Date: Apr. 17, 2003

(54) Method for compressing a fuel cell stack during assembly

(75) Inventors: Graham Edward Hill, Vancouver (CA); Paul F. Meharg, Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 09/981,322

(22) Filed: Oct. 15, 2001

(51) Int. Cl. H01M 8/04

(52) U.S. Cl. 429/13; 429/35; 429/26

(57) ABSTRACT

A method useful during the assembly of fuel cell stacks having resilient seals and/or MEAs is provided. The method comprises heating fuel cells of a fuel cell stack, and applying a compressive force to the fuel cell stack.

### BACKGROUND OF THE INVENTION

1. Field of the Invention

The present invention relates to methods for compressing a fuel cell stack during assembly to ensure proper sealing of the fuel cell components in the assembled stack.

2. Description of the Related Art

Fuel cells typically comprise a pair of electrodes and an electrolyte interposed between them. Solid polymer electrolyte fuel cells, for example, have an ion exchange membrane disposed between the electrodes, usually in the form of an integrated membrane electrode assembly, or MEA. Separator plates are located adjacent to the electrodes, and multiple fuel cells are connected together to form a fuel cell stack.

Fuel cell stacks typically employ a compression mechanism to apply a compressive force on the various fuel cell components. This is desirable for a number of reasons. For example, in order to seal reactant and coolant fluid stream passages to prevent leaks or inter-mixing of the various fluid streams, fuel cell stacks typically employ resilient seals between stack components. It is generally desirable to apply a compressive force to such seals in order to ensure adequate sealing. Compression of the stack is also desirable in order to ensure sufficient electrical contact across the surfaces of the plates and MEAs to provide the serial electrical connection among the fuel cells that make up the stack. Thus, a fuel cell stack typically needs to be properly compressed after final assembly in order for it to operate properly.

There can be hundreds of components in a fuel cell stack to be aligned and assembled for the stack to operate. During initial assembly the compressed seals tend to settle over time. As the seals settle, there is a loss of compressive force that can result in the loss of an effective seal between the fuel cell components. This, in turn, can result in internal and/or external leaks past the seals in the stack. For solid polymer electrolyte fuel cells, the MEA can also settle over time and this can contribute to the potential for leaks due to loss of compressive force.

One approach to this problem is to over-compress the stack after initial assembly to accelerate the settling of the seals and to ensure proper sealing of the stack under the normal compressive load. Unfortunately, over-compression of the stack can result in damage to plates and/or MEAs.

It is desirable to have a method of assembling a fuel cell stack that can expedite proper sealing between fuel cell components and enable a faster transition from assembly to operation of the stack, without placing undue stress on fuel cell components.

### BRIEF SUMMARY OF THE INVENTION

A method useful during the assembly of fuel cell stacks having resilient seals and/or MEAs is provided. The method comprises heating fuel cells of a fuel cell stack, and applying a compressive force to the fuel cell stack.

The compressive force applied to the stack may be less than or equal to the compressive force exerted on the stack during normal operation. The applied compressive force may also exceed the compressive force exerted on the stack during normal operation, if desired.

The fuel cells may be heated by flowing a heat exchange fluid through the stack. The heat exchange fluid may be directed through fluid flow channels of the stack.

### DETAILED DESCRIPTION OF THE INVENTION

The present method comprises heating the fuel cells of a fuel cell stack and compressing the fuel cell stack.

Fuel cell stacks typically employ resilient seals to effect sealing between fuel cell components. Separate gaskets may be used, or gaskets/seals can be incorporated or integral with various fuel cell components. Non-limiting examples of such resilient seal arrangements are described in U.S. Pat. Nos. 5,176,966, 5,284,718, 5,300,370, 5,464,700, 5,514,487, 5,976,726, and 6,057,054, incorporated herein by reference in their entirety.

During assembly of a fuel cell stack comprising resilient seals, a compressive force is applied to the stack to ensure, among other things, proper sealing of the various stack components. However, new seals tend to settle over time, i.e., their resistance to compression is initially greater than normal and decreases until a steady state is reached, at which time the seals are said to be relaxed. The settling of the seals may result in loss of compressive force on the stack. If an insufficient compressive force is applied to the stack, the seals may not create an effective seal between fuel cell components and leaks can occur during operation of the stack.

For solid polymer electrolyte fuel cell stacks, the MEA can also settle over time and this can contribute to the potential for leaks due to loss of compressive force on the stack.

One approach to this problem is to compress the stack and allow the seals and/or MEAs to settle, and then compress the stack again to ensure an appropriate compressive force is applied. Depending on the materials used, it can take days for the seals and/or MEAs to relax. This amount of time is undesirable for high-volume manufacturing of fuel cell stacks.

Another approach is to over-compress the stack to accelerate settling of the seals and/or MEAs. In this context, over-compressing the stack means applying a compressive force to the stack that is significantly greater than the force exerted on the stack during normal operation until the seals and/or MEAs settle. For example, this compressive force may approach or exceed the design tolerance of the stack.

While this approach does reduce the time it takes for the seals and/or MEAs to relax, it also increases the risk of damage to fuel cell components. For example, seals can shear, separator plates can deform or crack, and MEAs can also be damaged. Damaged fuel cell components can result in such problems as leaks, electrical shorts, or poor stack performance.

The present method expedites settling of the resilient seals and/or MEAs during assembly of a fuel cell stack. The present method may be employed during the manufacturing and assembly of fuel cell stacks. In addition, the present method may be employed during assembly of fuel cell stacks that have been disassembled for repair or routine maintenance.

The assembled fuel cell stack is compressed while the fuel cells are heated. The compressive force applied to the stack may be less than or equal to the compressive force exerted on the stack during normal operation. If desired, the compressive force applied to the stack may exceed the compressive force exerted on the stack during normal operation, provided that over-compression of the stack is avoided.

In one embodiment of the present method, the fuel cells are heated by flowing a heat exchange fluid through the stack. For example, the heat exchange fluid may be directed through the reactant flow passages of the fuel cells, either the fuel or oxidant flow passages. Where the stack comprises coolant flow channels, the heat exchange fluid may directed therethrough. If desired, the heat exchange fluid may be directed through two or more of the fuel, oxidant and coolant flow channels.

The heat exchange fluid may be a liquid, such as water, for example. Alternatively, the heat exchange fluid may be a dry gas, or a wet gas such as steam. The choice of heat exchange fluid is not essential to the present method, and persons skilled in the art can select suitable heat exchange fluids for a given application.

The temperature to which the fuel cells are heated is also not essential to the present method. Of course, as the temperature increases the rate of settling of the seals and/or MEAs increases. At the same time, various fuel cell components may be damaged at higher temperatures. For example, it is not recommended to heat solid polymer electrolyte fuel cells to the melt flow temperature of the membrane in the MEA, as this may increase the risk of the electrodes contacting each other, resulting in an electrical short. Similarly, the resilient seals may permanently deform if heated above a critical temperature dictated by the seal material, and this may adversely affect sealing of fuel cell components in the stack. As another example, separator plates may be fabricated from expanded graphite sheet material impregnated with a curable resin, such as methacrylate resin, for example. At higher temperatures, the resin in the plates may soften, which can result in deformation of the plates, which may adversely affect sealing and/or fuel cell performance. Thus, there is a trade-off between reducing the time for settling the seals and/or MEAs and damaging fuel cell components by heating them. Suitable temperature ranges for heating the fuel cells of the stack depend on such factors as the materials used in the fuel cell components, the compressive force applied to the stack, the heat exchange fluid employed, and the desired time to achieve settling of the seals and/or MEAs. For example, where water is used as the heat exchange fluid, a temperature range of about 50° C. to about 100° C. is generally adequate. Persons skilled in the art can determine a suitable temperature range for a given application.

The compressive force is typically applied for a time sufficient to relax the seals and/or MEAs of the stack. The fuel cells can be heated before the compressive force is applied, if desired. Alternatively, the fuel cells can be heated and the compressive force applied at the same time.

The present method expedites uniform settling of the resilient seals and/or MEAs during assembly of a fuel cell stack, without causing damage to the fuel cell components. In trials, solid polymer electrolyte fuel cell stacks comprising expanded graphite sheet separator plates were assembled and a compressive force equal to the compressive force exerted on the stack during normal operation was applied. While the stack was under compression, water at a temperature of about 70° C.-75° C. was directed through the coolant flow channels at an inlet pressure of about 35 kPa. The settling time for the seals and MEAs of the stack was reduced from several days under the same load (without heating) to about 1 hour. This represents a substantial timesaving in the final assembly of the stack, while avoiding the risk of damaging fuel cell components due to over-compression.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. A method comprising:
(a) heating fuel cells of a fuel cell stack, the stack comprising resilient seals; and
(b) applying a compressive force to the fuel cell stack.

2. The method of claim 1 wherein the applied compressive force is less than or equal to the compressive force exerted on the stack during normal operation.

3. The method of claim 1 wherein the fuel cells are heated by flowing a heat exchange fluid through the stack.

4. The method of claim 3 wherein the fuel cell stack further comprises coolant flow channels and the heat exchange fluid is directed therethrough.

5. The method of claim 3 wherein the fuel cell stack further comprises fuel flow channels and the heat exchange fluid is directed therethrough.

6. The method of claim 3 wherein the fuel cell stack further comprises oxidant flow channels and the heat exchange fluid is directed therethrough.

7. The method of claim 3 wherein the fuel cell stack further comprises coolant flow channels, fuel flow channels and oxidant flow channels and heat exchange fluid is directed through at least two of the coolant, fuel and oxidant flow channels.

8. The method of claim 3 wherein the heat exchange fluid comprises water.

9. The method of claim 1 wherein the fuel cells are heated to at least 50° C.

10. The method of claim 1 wherein the compressive force is applied for a time sufficient to relax the resilient seals.

11. The method of claim 1 wherein the fuel cells each comprise a membrane electrode assembly and the compressive force is applied for a time sufficient to relax the membrane electrode assemblies.

12. The method of claim 1 wherein steps (a) and (b) occur simultaneously.

13. The method of claim 1 wherein
the fuel cell stack further comprises coolant flow channels,
the fuel cells comprise at least one separator plate, the separator plate comprising an expanded graphite sheet material impregnated with a resin, and a membrane electrode assembly in contact with the separator plate,
the fuel cells are heated by flowing through the coolant flow channels a water stream that is heated to at least 70° C., and
the compressive force is applied for about 1 hour.

14. The method of claim 13 wherein the applied compressive force is less than or equal to the compressive force exerted on the stack during normal operation.
